(19) United States
(12) Patent Application Publication
(10) Pub. No.: US 2011/0177318 A1
(43) Pub. Date: Jul. 21, 2011

(54) CERAMIC COMPOSITE ARTICLE AND METHOD THEREFOR

(76) Inventors: Michael A. Kmetz, Colchester, CT (US); Kirk C. Newton, Enfield, CT (US)

(21) Appl. No.: 12/689,507

(22) Filed: Jan. 19, 2010

(51) Int. Cl. B32B 18/00; D02G 3/36; B32B 5/02; B28B 23/02

(52) U.S. Cl. 428/293.4; 428/378; 428/367; 264/134

(57) ABSTRACT

A ceramic composite article includes ceramic reinforcement fibers each having an outer surface and a continuous zinc oxide coating disposed on the ceramic reinforcement fibers and in contact with the outer surfaces.

### BACKGROUND

This disclosure relates to ceramic matrix composites. Fiber-reinforced ceramic matrix composites are known and used in high temperature structural applications, such as aerospace applications. The mechanical strength and toughness of a ceramic matrix composite is dependent to a large degree on the interface between the reinforcing fibers and the matrix. This interface is responsible for bonding and debonding between the fiber and the matrix. If bonding between the fiber and the matrix is strong, the composite acts as a monolith and fails in a brittle manner. On the other hand, if the bonding between the fiber and the matrix is weak, the fibers pull away from the matrix such that there is interfacial debonding and crack deflection which toughens the composite. In some example ceramic matrix composites, an interfacial material between the fibers and the matrix is used to enhance the interfacial properties.

### SUMMARY

An exemplary ceramic composite article includes ceramic reinforcement fibers each having an outer surface and a continuous zinc oxide coating disposed on the ceramic reinforcement fibers and in contact with the outer surfaces.

In another aspect, a ceramic composite article includes an oxide ceramic matrix, oxide ceramic reinforcement fibers having an outer surface and being dispersed within the oxide ceramic matrix, and a continuous zinc oxide coating disposed on the oxide ceramic reinforcement fibers and in contact with the outer surfaces.

An exemplary method for processing a ceramic composite article includes depositing a continuous zinc oxide coating directly onto outer surfaces of ceramic reinforcement fibers and forming a ceramic matrix in which the coated ceramic reinforcement fibers are dispersed.

### BRIEF DESCRIPTION OF THE DRAWINGS

The various features and advantages of the disclosed examples will become apparent to those skilled in the art from the following detailed description. The drawings that accompany the detailed description can be briefly described as follows.

FIG. 1 illustrates an example ceramic composite article.

FIG. 2 illustrates another example ceramic composite article.

### DETAILED DESCRIPTION OF THE PREFERRED EMBODIMENT

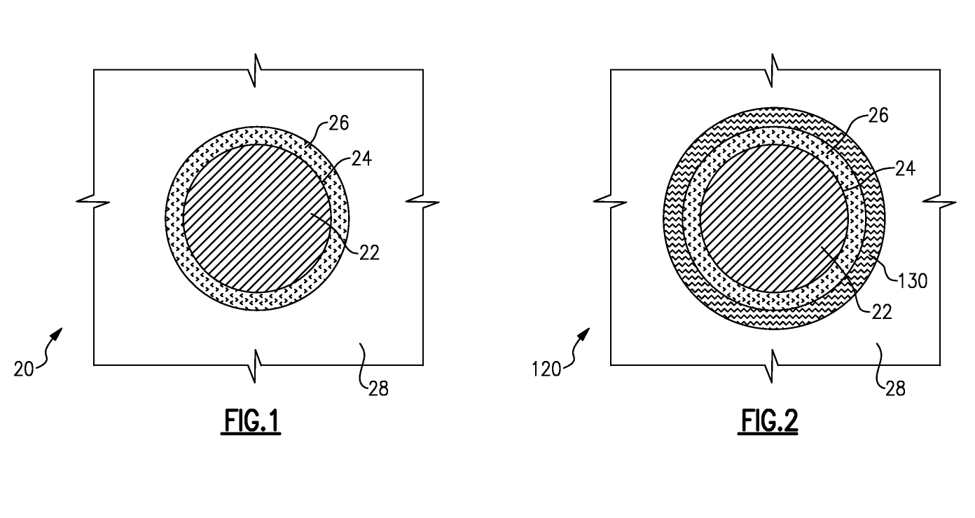

FIG. 1 illustrates selected portions of an example ceramic composite article 20 that may be used in high temperature, structural applications. In some examples, the ceramic composite article 20 may be a turbine engine component. It is to be understood, however, that the ceramic composite article 20 is not necessarily limited to any type of component.

The ceramic composite article 20 includes a plurality of ceramic reinforcement fibers 22 (one shown) each having an outer surface 24. A continuous zinc oxide coating 26 (ZnO) is disposed on the outer surface 24 of the ceramic reinforcement fiber 22 such that the continuous zinc oxide coating 26 is in contact with the outer surface 24. The continuous zinc oxide coating 26 may completely surround the ceramic reinforcement fibers 22. The continuous zinc oxide coating 26 (ZnO) may be less than about 0.5 micrometers thick. In some examples, the continuous zinc oxide coating 26 (ZnO) may be approximately 0.1-0.3 micrometers thick. It is to be understood that although a single ceramic reinforcement fiber 22 is shown, the ceramic composite article 20 includes a plurality of such fibers in a desired arrangement, such as a fabric or other type of fiber structure. That is, this disclosure is not limited to any type of fiber structure.

One premise of this disclosure is that the use of the continuous zinc oxide coating 26 as an interfacial material between the ceramic reinforcement fibers 22 and the ceramic matrix 28 provides desirable bonding/debonding properties because of the relative softness of zinc oxide that allows for compliancy while maintaining high temperature resistance and the ability to deposit the zinc oxide without forming a chemical bond between the zinc oxide and the underlying fiber. As an example, zinc oxide generally has a hardness of about 4.0 on the Mohs scale whereas, for comparison, talc has a hardness of 1.0 and diamond has a hardness of 10. Moreover, zinc oxide has a relatively high melting point of around 1977° C. and therefore is not expected to thermally degrade in high temperature applications or exhibit a substantial reduction in mechanical characteristics at elevated use temperatures.

In the illustrated example, the ceramic reinforcement fiber 22 with continuous zinc oxide coating 26 is dispersed within a ceramic matrix 28. That is, the ceramic matrix 28 extends between the ceramic reinforcement fibers 22 to form the body of the ceramic matrix composite article 20.

The materials selected for the ceramic reinforcement fibers 22 and the ceramic matrix 28 may depend upon the intended end use. In some examples, the ceramic reinforcement fibers 22 may be alumina (Al₂O₃) or silicon carbide (SiC). It is to be understood however, that given this description, one of ordinary skill in the art will be able to select other types of ceramic materials to suit their particular needs. Likewise, the ceramic material selected for the ceramic matrix 28 may also be selected to suit the particular needs of an end use application. In a few examples, the ceramic matrix 28 may be silicon carbide (SiC), aluminum silicate (mullite, Al₆Si₂O₁₃), alumina, silicon oxynitride, or even mixtures thereof.

FIG. 2 illustrates another example ceramic composite article 120. In this disclosure, like reference numerals designate like elements where appropriate, and reference numerals with the addition of one-hundred or multiples thereof designate modified elements. The modified elements are understood to incorporate the same features and benefits of the corresponding original elements. In this example, the ceramic composite article 120 additionally includes a protective coating 130 disposed directly on the continuous zinc oxide coating 26. For instance, the protective coating 130 may be a continuous oxide coating of silica, alumina, or other type of stable oxide.

The protective coating 130 serves to protect the underlying continuous zinc oxide coating 26 from chemical reduction to zinc metal under reducing atmospheres. For instance, the ceramic composite article 120 may be exposed to a reducing atmosphere in conjunction with deposition of the ceramic matrix 28 around the coated fibers 22. In addition, the ceramic composite article 120 may used in a reducing atmosphere such that it is desirable to protect the continuous zinc oxide coating 26 from chemical reduction.

In some examples where the material selected for the ceramic matrix 28 does not require using a reducing atmosphere or the intended end use environment of the ceramic composite article 120 will not include a reducing atmosphere, there may be no need to use the protective coating 130. Thus, the protective coating 130 may be used in instances where silicon carbide is selected as the ceramic matrix 28 due to the reducing atmosphere that may be used to deposit the silicon carbide. However, if the ceramic matrix 28 is an oxide material, such as alumina, aluminum silicate or silicon oxynitride, there may be no need to use the protective coating 130, as these ceramic matrix materials do not typically utilize reducing atmospheres during deposition.

In some examples that may be suited for use in oxidizing atmospheres, the material selected for the ceramic reinforcement fibers 22 and the ceramic matrix 28 may be oxide materials. For instance, the ceramic reinforcement fibers 22 may be oxide ceramic reinforcement fibers and the ceramic matrix 28 may be an oxide ceramic matrix. For instance, the ceramic reinforcement fibers 22 may be alumina and the ceramic matrix 28 may be aluminum silicate, alumina, silicon oxynitride, or even combinations thereof.

The ceramic composite articles 20 and 120 may be fabricated by depositing the continuous zinc oxide coating 26 directly onto the outer surfaces 24 of the ceramic reinforcement fibers 22. The ceramic matrix 28 may then be formed such that the coated ceramic reinforcement fibers 22 are dispersed within the ceramic matrix 28. In some examples, the continuous zinc oxide coating 26 may be deposited onto the outer surfaces 24 using chemical vapor deposition techniques, which does not degrade the underlying ceramic reinforcement fibers 22 or form a chemical bond between the ceramic reinforcement fibers 22 and the continuous zinc oxide coating 26. For instance, scanning Auger microscopy was used to determine the composition as a function of depth through the interface between the continuous zinc oxide coating 26 and the ceramic reinforcement fibers 22. In the case of chemical vapor deposition, there was a clean transition between the coating and the fibers. In other words, the continuous zinc oxide coating 26 did not react with the fibers to form intermediates or carbonaceous species at the interface that could diminish the desired interface properties. After deposition of the continuous zinc oxide coating 26, the ceramic matrix 28 may be deposited onto the coated ceramic reinforcement fibers 22 using known techniques, such as sol-gel processing, chemical vapor deposition, preceramic polymer pyrolysis, or other known techniques.

In one example chemical vapor deposition technique using a precursor of zinc acetate dihydrate, the continuous zinc oxide coating 26 was deposited in a hot-walled isothermal, isobaric reactor according to the reactions shown below in Equations (1) and (2). The reactor included of a fused silica (quartz) tube of about 7.6 centimeters in diameter with a mullite insert that was about 6.35 centimeters in diameter. The mullite insert was used to protect the quartz tube from the deposited zinc oxide. Stainless steel end caps with fluoroelastomer o-rings and compression fittings were used to seal off the reactor and deliver the precursor gases. Mass flow controllers were used to control the flow of gaseous precursors to approximately 100-300 sccm. Several absolute pressure transducers were used to monitor the pressure inside the reactor. A liquid nitrogen trap and a particulate trap were used to collect the by-products. A vacuum pump provided a vacuum.

$$\begin{matrix}4 [ {Zn ( {CH}_{3} {CO}_{2} )}_{2} \cdot 2 {H}_{2} O ] {{\to }^{Δ}}_{P < 1 atm} {Zn}_{4} {O ( {CH}_{3} {CO}_{2} )}_{6 ( s )} + 7 {H}_{2} {O}_{( g )} + {( {CH}_{3} CO )}_{2} {O}_{( g )} & ( 1 ) \\ {Zn}_{4} {O ( {CH}_{3} {CO}_{2} )}_{6 ( s )} {\to }^{Δ} 4 {ZnO}_{( s )} + {3 [ {( {CH}_{3} {CO}_{2} )}_{2} O ]}_{( g )} & ( 2 )\end{matrix}$$

A section of ceramic cloth of the ceramic reinforcing fibers 22 was first placed into the quartz tube. A precursor holder (around 10 centimeters long) was made by simply folding aluminum foil into a boat shape form. The boat was then filled approximately halfway up with the zinc acetate (around 35 g). The precursor boat was then loaded into the quartz tube inside the vaporizing furnace and the whole tube was evacuated down to less than 1 ton. The reactor and precursor vaporizer furnaces were then brought up to the desired temperature of approximately 250° C. and 300-500° C., respectively. The reaction was considered started when a nitrogen carrier gas was allowed to flow over the precursor boat. A deposition time of approximately 1-4 hours may be used to deposit the continuous zinc oxide coating 26 with a thickness of less than approximately 0.5 micrometers. Ceramic composite articles 20 made in such a manner exhibited fiber pull-out from the ceramic matrix 28 and crack deflection along the interface of the continuous zinc oxide coating 26. Therefore, the continuous zinc oxide coating 26 is beneficial as an interface material for toughening the composite ceramic article 20.

In a further example utilizing the protective coating 130, silicon dioxide was deposited from the thermal decomposition of reagent grade tetraethylorthosilicate (TEOS). To deposit the silicon dioxide coating on the zinc oxide coated fabric, nitrogen was bubbled through TEOS at a rate of 125 sccm. The deposition temperature was held at 700° C. and the reactor was kept at atmospheric pressure. Deposition times may be varied in accordance with the quantity of cloth used, and the desired thickness of the silicon dioxide layer. When the silicon dioxide layer was deposited to protect the zinc oxide from being reduced during the matrix infiltration process, the layer was kept around 100 um. When this process was used to deposit a silicon dioxide matrix to make a Nextel/ZnO2/SiO₂ composite the infiltration time were around 24 hrs.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A ceramic composite article comprising:
ceramic reinforcement fibers each having an outer surface; and
a continuous zinc oxide coating disposed on the ceramic reinforcement fibers and in contact with the outer surfaces.

2. The ceramic composite article as recited in claim 1, wherein the ceramic reinforcement fibers are alumina fibers.

3. The ceramic composite article as recited in claim 1, wherein the ceramic reinforcement fibers are silicon carbide fibers.

4. The ceramic composite article as recited in claim 1, further comprising a continuous oxide coating disposed directly on the continuous zinc oxide coating.

5. The ceramic composite article as recited in claim 1, further comprising a continuous coating of silica or alumina disposed directly on the continuous zinc oxide coating.

6. The ceramic composite article as recited in claim 1, further comprising a ceramic matrix throughout which the ceramic reinforcement fibers are dispersed.

7. The ceramic composite article as recited in claim 6, wherein the ceramic matrix is selected from a group consisting of alumina, aluminum silicate, silicon oxynitride, and combinations thereof.

8. The ceramic composite article as recited in claim 6, wherein the ceramic reinforcement fibers are alumina fibers, and the ceramic matrix is an oxide.

9. The ceramic composite article as recited in claim 6, wherein the ceramic reinforcement fibers are silicon carbide fibers, the ceramic matrix is silicon carbide, and there is a continuous coating of silica or alumina disposed directly on the continuous zinc oxide coating.

10. A ceramic composite article comprising:
an oxide ceramic matrix;
oxide ceramic reinforcement fibers each having an outer surface and being dispersed within the oxide ceramic matrix; and
a continuous zinc oxide coating disposed on the oxide ceramic reinforcement fibers and in contact with the outer surfaces.

11. The ceramic composite article as recited in claim 10, wherein the oxide ceramic matrix is selected from a group consisting of alumina, silicon oxynitride, aluminum silicate and combinations thereof.

12. The ceramic composite article as recited in claim 10, wherein the oxide ceramic reinforcement fibers are alumina fibers.

13. A method for processing a ceramic composite article, comprising:
depositing a continuous zinc oxide coating directly onto outer surfaces of ceramic reinforcement fibers; and
forming a ceramic matrix in which the coated ceramic reinforcement fibers are dispersed.

14. The method as recited in claim 13, including forming the ceramic matrix from a group consisting of silicon carbide, aluminum silicate, silicon oxynitride, alumina, and combinations thereof.

15. The method as recited in claim 13, wherein the ceramic reinforcement fibers are alumina fibers or silicon carbide fibers.

16. The method as recited in claim 15, wherein the ceramic reinforcement fibers are alumina fibers if the ceramic matrix is an oxide.
